(19) United States
(12) Patent Application Publication
(10) Pub. No.: US 2013/0111412 A1
(43) Pub. Date: May 2, 2013

(54) USER INTERFACES AND ASSOCIATED APPARATUS AND METHODS

(71) Applicants: Susanna Sura, Turku (FI); Mikko Petteri Kamarainen, Turku (FI)

(72) Inventors: Susanna Sura, Turku (FI); Mikko Petteri Kamarainen, Turku (FI)

(73) Assignee: NOKIA CORPORATION, Espoo (FI)

(21) Appl. No.: 13/281,906

(22) Filed: Oct. 26, 2011

(51) Int. Cl. G06F 3/048

(52) U.S. Cl. 715/845

(57) ABSTRACT

An apparatus comprising at least one processor and at least one memory including computer program code. The at least one memory and the computer program code configured to, with the at least one processor, cause the apparatus to perform at least the following: receive user input indicative of one or more of a plurality of selectable items in a hierarchical structure that are to be hidden; and display, based at least in part on the user input, a user interface with the one or more of the selectable items hidden.

### TECHNICAL FIELD

The present disclosure relates to the field of user interfaces, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), tablet PCs, smartphones, etc.

The portable electronic devices/apparatus according to one or more disclosed aspects/embodiments may provide one or more audio/text/video communication functions (e.g. tele-communication, video-communication, and/or text transmission (Short Message Service (SMS)/ Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

It is known for Microsoft Windows to offer possibility to hide icons based on how rarely they are used. Also, it is known that SBSettings of the iPhone can be used to hide individual icons.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus comprising:
at least one processor; and
at least one memory including computer program code,
the at least one memory and the computer program code configured to, with the at least one processor, cause the apparatus to perform at least the following:
receive user input indicative of one or more of a plurality of selectable items in a hierarchical structure that are to be hidden; and
display, based at least in part on the user input, a user interface with the one or more of the selectable items hidden.

In this way, the user interface can be simplified and tailored to a user's specific needs. In some examples, displaying the user interface in this way can enable fewer keystrokes, or selections, by a user to initiate desired functionality.

Hiding a selectable item may involve preventing the item being displayed to a user during normal operation of the apparatus, but not removing or de-installing the associated functionality from the apparatus.

The apparatus may be configured to display, based at least in part on the user input, a user interface that includes those selectable items that are not the one or more selectable items that are to be hidden.

The user input may be understood to be/encompass user input signalling representative of an interaction by a user with an interface (for example keypad, touch-sensitive screen, display, mouse, cursor, voice control, remote control, and the like) of an apparatus/device.

The user input may represent one or more of the plurality of selectable items that are to be hidden or one or more of the plurality of selectable items that are to be displayed. That is, the user input can provide the indication of one or more of a plurality of selectable items in a hierarchical structure that are to be hidden in one of at least two way: by identifying which items are to be displayed (non-hidden) or by identifying which items are to be hidden.

The hierarchical structure may be a menu structure. The user input may be indicative of a plurality of the selectable items at different levels in the menu structure. The menu structure may be displayed as a single view, a list view or a grid view, as non-limiting examples.

The hierarchical structure may be a folder structure. The user input may be indicative of a plurality of the selectable items in folders and sub-folders in the folder structure.

The user input may be indicative of one or more preset selectable items in a hierarchical structure that are to be hidden. Using preset selectable items provides a user with a convenient way of hiding one or more of the items by making a single selection of a desired preset identifier. The preset selectable items may be predefined by a third party, such as a manufacturer of a mobile telephone or smartphone, or may be configured by a user of the apparatus. In any case, the use of the preset selectable items can provide a quick and easy way for a user to change the display of the apparatus.

The one or more preset selectable items may be associated with a user selectable “profile” or “menu style”.

One or more preset selectable items may be creatable and/or modifiable by a user. In this way a user can personalise a display, and provide a convenient way of accessing that personalised display by resetting their preferences.

The apparatus may be further configured to: receive user input indicative of a desire to select which of the plurality of selectable items are to be hidden; and display a user interface with all of the plurality of selectable items, including the selectable items that have been identified as hidden. The apparatus may then receive the user input indicative of one or more of a plurality of selectable items in a hierarchical structure that are to be hidden or un-hidden. This can enable a user to reconfigure the display by providing the functionality for a user to un-hide items that have previously been hidden.

The apparatus may be configured to display, as a home screen, the user interface for the top level in the hierarchical structure with the one or more of the selectable items hidden. An “exit” option from the user interface may not be required when viewing the menu structure as a home screen because all of the non-hidden items are always displayed to a user.

One or more of the selectable items may be configured to be prevented from being hidden. One or more of the selectable items may be configured such that they are prevented from being hidden; that is they may not be hide-able. For example, a selectable item associated with “settings” may be configured such that it cannot be hidden in order to provide a user with the functionality for reconfiguring the hidden selectable items in the future.

The apparatus may be configured to determine if the number of selectable items in a level of a branch of the hierarchical structure is less than or equal to a threshold number, and if it is, display the selectable item/s at a higher level of that branch in the hierarchical structure.

The threshold number may be one such that a selectable item is displayed at a higher level if it is the only item at a level of the branch. Alternatively, the threshold number may be automatically set based at least in part on the number of selectable items in the higher level of that branch. For example, if the higher level has two selectable items and the user interface can display up to four selectable items for the higher level, then the threshold may be set as two (the number of free spaces for displaying additional selectable items in the higher level).

In this way, the apparatus can determine whether or not one or more selectable items may be displayed/moved to a higher level in a branch of a structure.

This functionality reduces the number of user input operations (which may be referred to as keystrokes) that are required for a user to access desired functionality. In addition, the user interface is more user friendly as the user does not have to navigate through a hierarchical structure with only one option at each level, which could feel like a waste of time to the user. Further still, the processing overhead of the apparatus may be reduced as it is not required to redisplay the user interface for each level of the hierarchical structure for which there is only one selectable item

The apparatus may be configured to display the determined selectable item/s at the highest level of that branch in the hierarchical structure for which the number of selectable items is less than or equal to the threshold number. The apparatus may be configured to display the determined selectable item at the highest level of that branch in the hierarchical structure for which there is only one selectable item in each level of the branch. In this way, any intermediate levels in the hierarchical structure (such as intermediate folders or intermediate menu options) can be automatically hidden. For a branch of the hierarchical structure that contains only one, or less than the threshold number of, selectable item/s for each level in the branch, the top level item in the branch can be replaced by the selectable item/s at the lowest level in the branch and/or from lower levels in the branch.

The apparatus may be configured to set the size of a representation for each of the selectable items to be displayed in accordance with the number of selectable items that are to be hidden (or alternatively, the number of selectable items that are to be displayed) from the user interface. The apparatus may be configured to resize one or more of the representations in response to a user hiding or unhiding selectable items.

The representation of a selectable item may be an icon.

The apparatus may be configured to set the size of the representations such that all of the displayed representations occupy a predefined region of the user interface. The predefined region of the user interface may be substantially all of the user interface. In this way, efficient use of the user interface can be made as unused display space can be reduced. The likelihood of a user inadvertently selecting an incorrect item can also be reduced because the representations of the selectable items can be resized to maximise the representations for a given display. This may be particularly advantageous for apparatus and devices that have a touch screen display.

The apparatus may be at least one of a portable electronic device, circuitry for a portable electronic device, a pocket computer, a laptop computer, a desktop computer, a tablet computer, a mobile phone, a smartphone, a monitor, a display, a personal digital assistant or a digital camera or a module for the same.

There may be provided a device comprising any apparatus disclosed herein.

According to a further aspect, there is provided a method comprising:
receiving user input indicative of one or more of a plurality of selectable items in a hierarchical structure that are to be hidden; and
displaying, based at least in part on the user input, a user interface with the one or more of the selectable items hidden.

According to a further aspect, there is provided a computer program comprising computer program code configured to, when run on at least one processor, perform at least the following:
receive user input indicative of one or more of a plurality of selectable items in a hierarchical structure that are to be hidden; and
display, based at least in part on the user input, a user interface with the one or more of the selectable items hidden.

The computer program code may be recorded on a carrier.

There may be provided apparatus comprising:
at least one processing means; and
at least one memory means including computer program code,
the at least one memory means and the computer program code configured to, with the at least one processing means, cause the apparatus to perform at least the following:
receive user input indicative of one or more of a plurality of selectable items in a hierarchical structure that are to be hidden; and
display, based at least in part on the user input, a user interface with the one or more of the selectable items hidden

There may be provided an apparatus comprising:
at least one processor; and
at least one memory including computer program code,
the at least one memory and the computer program code configured to, with the at least one processor, cause the apparatus to perform at least the following:
determine if the number of selectable items in a level of a branch of the hierarchical structure is less than or equal to a threshold number, and if it is, display the selectable item/s at a higher level of that branch in the hierarchical structure.

There may be provided a computer program comprising computer program code configured to, when run on at least one processor, perform at least the following:
determine if the number of selectable items in a level of a branch of the hierarchical structure is less than or equal to a threshold number, and if it is, display the selectable item/s at a higher level of that branch in the hierarchical structure.

The apparatus or computer program code may be configured to display the determined selectable item/s at the highest level of that branch in the hierarchical structure for which the number of selectable items is less than or equal to the threshold number. In this way, any intermediate levels in the hierarchical structure (such as intermediate folders or intermediate menu options) can be automatically hidden. For a branch of the hierarchical structure that contains only one selectable item for each level in the branch, the top level item in the branch can be replaced by the selectable item at the lowest level in the branch.

There may be provided a method comprising:
determining if the number of selectable items in a level of a branch of the hierarchical structure is less than or equal to a threshold number, and if it is, display the selectable item/s at a higher level of that branch in the hierarchical structure; and optionally,
displaying the determined selectable item/s at the highest level of that branch in the hierarchical structure for which the number of selectable items is less than or equal to the threshold number.

This functionality can reduce the number of user input operations that are required for a user to access desired functionality and reduce processing overhead as it is not necessary to redisplay the user interface for each level of the hierarchical structure for which there is only one selectable item or for which better use of a display of a higher level can be made.

There may be provided an apparatus comprising:
at least one processor; and
at least one memory including computer program code,
the at least one memory and the computer program code configured to, with the at least one processor, cause the apparatus to perform at least the following:
set the size of a representation for each of a plurality of selectable items in a hierarchical structure to be displayed in accordance with the number of selectable items that are to be hidden from (or alternatively displayed on) a user interface.

There may be provided a computer program comprising computer program code configured to, when run on at least one processor, perform at least the following:
set the size of a representation for each of a plurality of selectable items in a hierarchical structure to be displayed in accordance with the number of selectable items that are to be hidden from (or alternatively displayed on) a user interface.

The apparatus or computer code may be configured to resize one or more of the representations in response to user input indicative of hiding or unhiding selectable items.

There may be provided a method comprising:
setting the size of a representation for each of a plurality of selectable items in a hierarchical structure to be displayed in accordance with the number of selectable items that are to be hidden from (or alternatively displayed on) a user interface; and optionally
resizing one or more of the representations in response to user input indicative of hiding or unhiding selectable items

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to merely provide examples and is non-limiting.

### DESCRIPTION OF THE FIGURES

A description is now given, by way of example only, with reference to the accompanying drawings, in which:

FIGS. 1a and 1b illustrate example user interfaces according to an embodiment of the present disclosure;

FIGS. 2a and 2b illustrate user interfaces according to another embodiment of the present disclosure;

FIGS. 3a to 3h illustrate graphically how a user can customise a user interface according to an embodiment of the present disclosure;

FIGS. 4a to 4f illustrate functionality for unhiding selectable items according to an embodiment of the present disclosure;

FIGS. 5a to 5g illustrate graphically how one or more menu items can be hidden according to an embodiment of the present disclosure;

FIGS. 6a and 6b illustrate user interfaces according to an embodiment of the present disclosure;

FIGS. 7a to 7e illustrate user interfaces according to an embodiment of the present disclosure that can be used to activate a preset menu style;

FIGS. 8a to 8d illustrate the functionality of an embodiment of the present disclosure when a user decides to personalise a predefined menu style;

FIGS. 9a to 9c illustrate a further embodiment of personalising a preset menu style according to an embodiment of the present disclosure;

FIGS. 10a and 10b illustrate alternative functionality that can be provided when a user selects the edit menu items option of FIG. 9b;

FIGS. 11a to 11c illustrate user interfaces according to another embodiment of the present disclosure;

FIGS. 12a and 12b illustrate user interface according to an embodiment of the present disclosure;

FIG. 13 illustrates a process flow according to an embodiment of the present disclosure;

FIG. 14 illustrates an apparatus according to an embodiment of the present disclosure;

FIG. 15 illustrates an apparatus according to another embodiment of the present disclosure; and

FIG. 16 illustrates schematically a computer readable media providing a program according to an embodiment of the present disclosure.

### DESCRIPTION OF EXAMPLE ASPECTS/EMBODIMENTS

One or more embodiments disclosed herein relate to a customisable user interface, whereby a user can cause one or more of a plurality of selectable items in a hierarchical structure to be hidden. The hierarchical structure may be a menu structure or a folder structure, for example. In this way, a user interface can be more user friendly as it can be tailored to a user's particular needs. In addition, fewer keystrokes may be required by a user to initiate desired functionality.

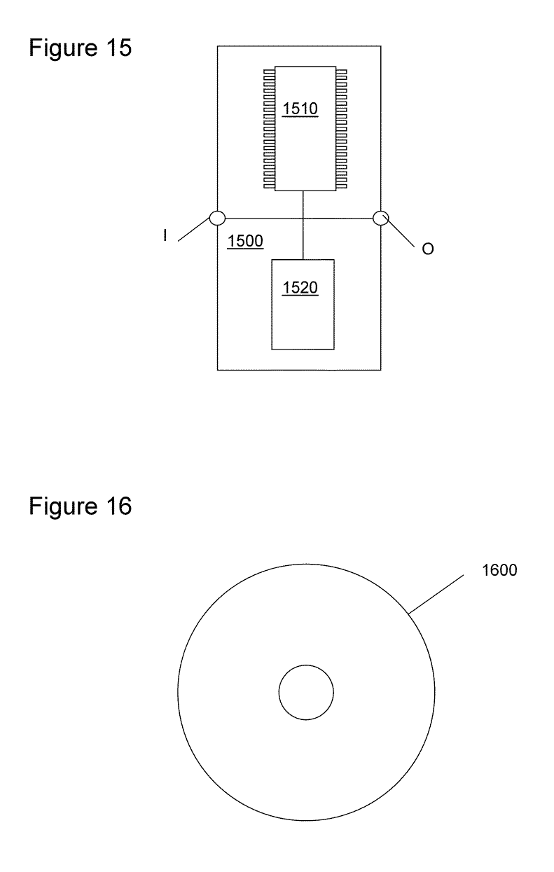

FIG. 15 shows an apparatus 1500 comprising a processor 1510, memory 1520, input I and output O that is one example of an apparatus that can be used to provide the functionality disclosed herein. In this embodiment only one processor and one memory are shown but it will be appreciated that other embodiments may utilise more than one processor and/or more than one memory.

In this embodiment the apparatus 1500 is an application specific integrated circuit (ASIC) for a portable electronic device 1400 with a touch sensitive display 1404 such as that shown in FIG. 14). In other embodiments the apparatus 1500 can be a module for such a device, or may be the device itself, wherein the processor 1510 is a general purpose CPU and the memory 120 is general purpose memory.

The input I allows for receipt of signalling to the apparatus 1500 from further components, such as components of a portable electronic device 1400 (like the touch-sensitive display 1404 of FIG. 14) or the like. The output O allows for onward provision of signalling from within the apparatus 1500 to further components. In this embodiment the input I and output O are part of a connection bus that allows for connection of the apparatus 1500 to further components.

The processor 1510 is a general purpose processor dedicated to executing/processing information received via the input I in accordance with instructions stored in the form of computer program code on the memory 1520. The output signalling generated by such operations from the processor 1510 is provided onwards to further components via the output O.

The memory 1520 is a computer readable medium (solid state memory in this example, but may be other types of memory such as a hard drive) that stores computer program code. This computer program code stores instructions that are executable by the processor 1510, when the program code is run on the processor 1510.

In this embodiment the input I, output O, processor 1510 and memory 1520 are all electrically connected to one another internally to allow for electrical communication between the respective components I, O, 1510, 1520. In this example the components are all located proximate to one another so as to be formed together as an ASIC, in other words, so as to be integrated together as a single chip/circuit that can be installed into an electronic device. In other embodiments one or more or all of the components may be located separately from one another (for example, throughout a portable electronic device).

One or more of the user interfaces disclosed herein can be presented on a display in accordance with at least the output signalling O of the apparatus 1500 of FIG. 15.

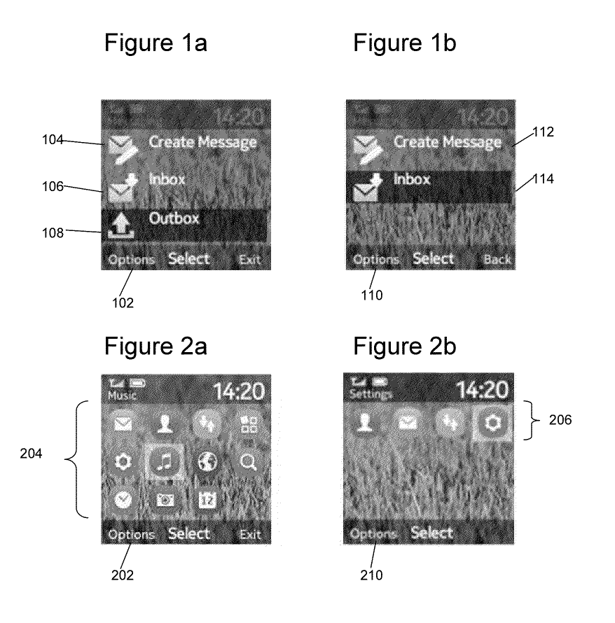

FIGS. 1a and 1b illustrate example user interfaces 102, 110 according to an embodiment of the present disclosure. In the examples that follow, operation of a mobile telephone or smartphone is described. However, it will be appreciated that embodiments of the present disclosure may not be limited to a particular device.

The user interface 102 of FIG. 1a includes three selectable items: a create message item 104; an inbox item 106; and an outbox item 108. This user interface 102 is configurable by a user such that one or more of the selectable items 104, 106, 108 can be hidden.

FIG. 1b illustrates a user interface 110 that has been customised such that only two of the selectable items 104, 106, 108 of FIG. 1a are visible. That is, one of the selectable items of FIG. 1a has been hidden. Only the create message item 112 and inbox item 114 are displayed as part of the user interface 110 of FIG. 1b; the outbox item 108 has been hidden. Further details of how a user can choose which of the selectable items to hide are provided below.

FIGS. 2a and 2b illustrate user interfaces 202, 210 according to another embodiment of the present disclosure. The user interface 202 of FIG. 2a includes eleven icons in a menu structure. These icons are examples of selectable items in a hierarchical structure.

User interface 210 of FIG. 2b has been customised by a user such that only four of the icons 204 shown in FIG. 2a are displayed in the user interface 210 of FIG. 2b. These four icons are identified with reference 206 in FIG. 2b.

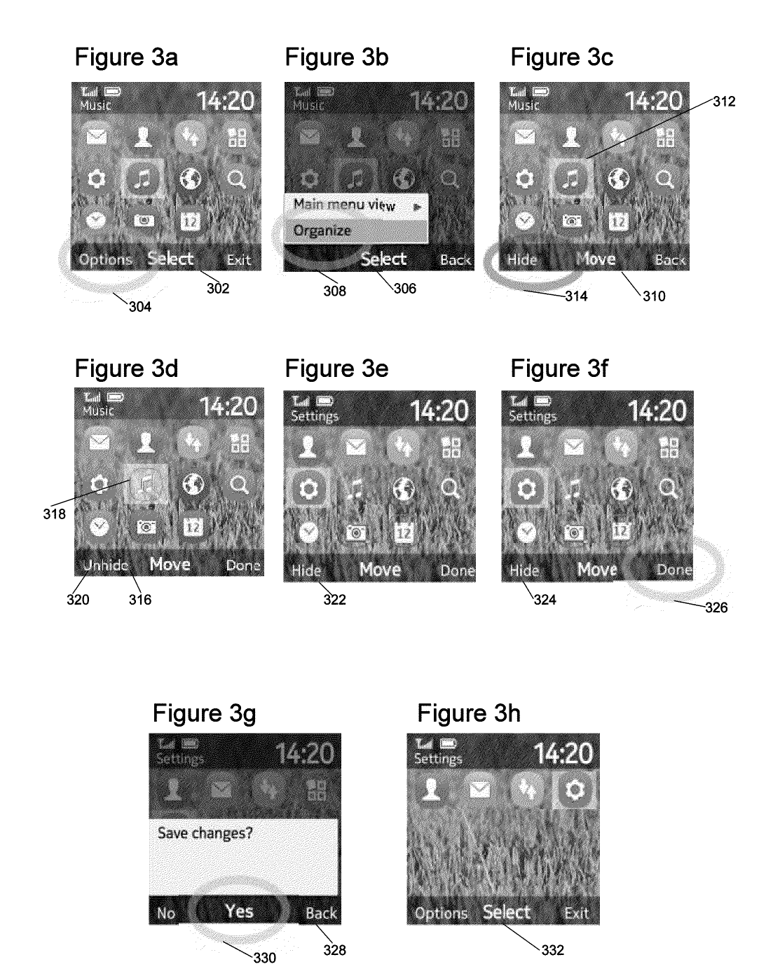

FIGS. 3a to 3h illustrate graphically how a user can customise a user interface according to an embodiment of the present disclosure. In this example, a plurality of icons are displayed in a menu structure. The menu structure is an example of a hierarchical structure.

The user interface 302 of FIG. 3a includes eleven icons that are available for use by the user. The user is also presented with an “options” button 304, which in this example and be activated by the left soft key. When the user selects the options button 304, the user interface of FIG. 3b is presented to the user.

The user interface 306 of FIG. 3b provides two options to a user. One of these options is to “organise” 308 the icons. It will be appreciated that a user may also be able to hide one or more of the available options that are displayed when options button 304 shown in FIG. 3a is selected. That is, one or more menu items/options may be considered as a selectable item that can be hidden.

When the user selects the “organise” option 308, they are presented with the user interface 310 of FIG. 3c.

In FIG. 3c, one of the icons 312 is highlighted. In accordance with the normal operation of these menus, the icon that is shown highlighted can be changed by pressing a directional button, or any other user input device. In order to hide an icon, the user ensures that the desired icon 312 is highlighted, and then selects a “hide” option 314. In this example, the “hide” option 314 is activated by pressing the left soft key of the device, although any other selection mechanism can be used, such as touching on the icon, hovering over the icon, double tapping on the icon, and the like.

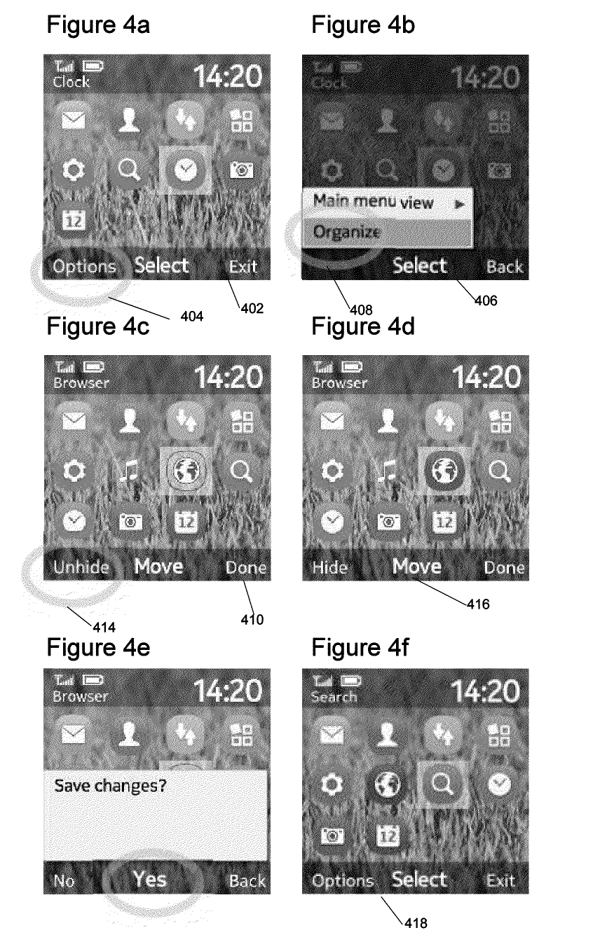

FIG. 3d illustrates a user interface 316 that is displayed after one of the icons has been selected to be hidden. The icon 318 to be hidden is shown as semi transparent in FIG. 3d in order to indicate that it has been selected. It will be appreciated that any other means of distinguishing the selected icon 318 from the unselected icons can be used. In addition, the previously presented “hide” option 314 has changed to an “unhide” option 320 in order to enable a user to deselect the icon. Further details of unhiding icons is provided below with reference to FIG. 4.

FIG. 3e illustrates a user interface 322 whereby seven of the original eleven icons have been selected for hiding, and are shown as semi transparent.

FIG. 3f illustrates a user interface 324 that is similar to the user interface 322 of FIG. 3e. Seven icons have been selected by the user for hiding, and the user can now select a “done” option 326. In this example, the “done” option is provided by the right soft key of the device.

The user interfaces of FIGS. 3a to 3f illustrate a “move” option that is available to a user in addition to the new “hide” and “unhide” functionality. An icon may for example be moved using a drag and drop operation, or selecting a place for the icon and then performing an operation that is configured to move the icon to a new place.

FIG. 3g illustrates a user interface 328 that is presented to a user after the “done” option 326 of FIG. 3f is selected. As shown in FIG. 3g, the user is prompted to confirm that they would like to make the changes that have been identified. In order to accept and save the changes, the user can select a “yes” option 330.

One or more of the user interactions that are illustrated in FIGS. 3a to 3g can be considered as a user providing input indicative of one or more selectable items in a hierarchical structure that are to be hidden. In other examples, a user could select items that are to be displayed/kept instead of selecting items that are to be hidden.

The resultant user interface 332 is shown in FIG. 3h. The seven icons that were selected by the user for hiding are no longer visible on the user interface 332. The only icons that are visible are those that were not selected for hiding by the user.

It will be appreciated that any known user input devices and mechanisms can be used, and that embodiments of the present disclosure are not limited to use of soft keys as illustrated in FIGS. 3a to 3h.

Optionally, the functionality illustrated by FIG. 3 can also include a preview option. That is, a user can select the preview option in order to cause the display to show those hidden icons/items in a different color/shaded/transparent etc. This could be displayed for a few seconds, or remain displayed until the user exited this “preview” mode. The user then could see has been hidden. Optionally, the user could then also be offered to “Unhide” any of the hidden items in which case they would be reshown in the user interface and be selectable again. The user could, for example, have an option to show hidden icons in a single place, or in an existing menu/folder such as a home screen that shows all of the hidden icons. Alternatively, the hidden icons could be shown when the user is in a particular level in the folder-like structure, or in a menu structure.

FIGS. 4a to 4f illustrate functionality for unhiding selectable items according to an embodiment of the present disclosure.

FIG. 4a shows a user interface 402 that includes nine icons. These nine icons are a subset of the total number of icons that can be displayed on the user interface; two icons have been hidden. In order for a user to unhide one or both of the hidden icons, an “options” button 404 can be selected by the user.

When the user selects the “options” button 404 of FIG. 4a, the user interface 406 of FIG. 4b is displayed. The user interface 406 of FIG. 4b includes an “organise” button 408, selection of which causes the user interface 410 of FIG. 4c to be displayed.

The user interface 410 of FIG. 4c includes all icons that can be displayed to a user; both hidden and non-hidden icons are displayed. As discussed above with reference to FIG. 3c, a user can highlight one of the icons as shown with reference 412 in FIG. 4c. In FIG. 4c, the highlighted icon 412 is one that was previously hidden and therefore is not shown in FIG. 4a.

When a previously hidden icon 412 is highlighted, an “unhide” option 414 is provided to the user. The “unhide” option 414 can be activated by selecting a left soft key of the device. It will be appreciated from the description of FIGS. 3 and 4 that the functionality of the left soft key may be either “hide” 314 or “unhide” 414 in accordance with whether or not the associated icon 312, 412 is presently selected for hiding.

Returning to FIG. 4, the user interface 416 of FIG. 4d is presented to the user after they have unhidden the previously selected icon 412. The user can then select a “done” option in FIG. 4d, such that they are asked to confirm the changes in FIG. 4e. A revised user interface 418 of FIG. 4f is displayed with the previously hidden icon, now shown.

In some examples, the apparatus may be configured to unhide all or a subset of hidden icons/items in response to user selecting a global option in a user interface. For example an “Unhide all” option may be provided in a settings menu or elsewhere. In another embodiment, an “Unhide all in this level” option may be provided that can be used to unhide items/icons in a level of a hierarchical structure. Such a level may be as associated with a certain application or a menu, such as a messaging application. This can help a user to re-configure a previous configuration. These options can enable a plurality of items to be hidden simultaneously.

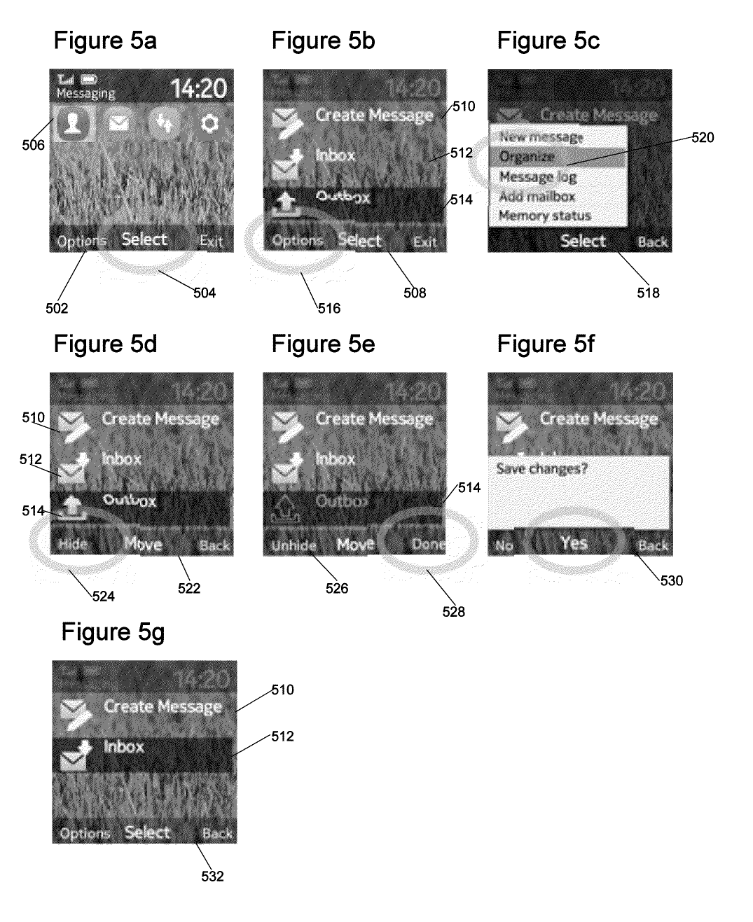

FIGS. 5a to 5g illustrate graphically how one or more menu items can be hidden according to an embodiment of the present disclosure.

FIG. 5a shows a user interface 502 that displays four icons to a user. The user can select an icon by pressing a select button 504. In this example, the user selects a messaging icon 506 such that the user interface 508 of FIG. 5b is displayed.

The messaging application of FIG. 5b has three selectable menu items: a create message item 510; an inbox item 512; and an outbox item 514. In addition to a user being able to select one of these items, a user can also select an options button 516 such that the user interface 518 of FIG. 5c is displayed.

As shown in FIG. 5c, five different options are displayed to a user, one of which is an “organise” option 520. If the user selects the “organise” option 520, they are presented with the user interface 522 of FIG. 5d.

The user interface 522 of FIG. 5d may enable a user to highlight one or more of the menu items 510, 512, 514. The user can then select a “hide” option 524 in order to subsequently hide that item, or those items if there is more than one.

In this example, a user has selected the “hide” option 524 when the outbox item 514 is highlighted in order to hide this item. FIG. 5e illustrates a user interface 526, in which the outbox item 514 is shown as ghosted, or otherwise distinguished from the other items 510, 512, to indicate that it has been selected to be hidden. The user can then select a “done” option 528 that will prompt them to confirm their changes as shown in the user interface 530 of FIG. 5f. The user interface 532 of FIG. 5g illustrates the re-displayed user interface with the outbox selectable item hidden. That is, only the create message item 510 and inbox item 512 are displayed. This simplified menu can improve the usability of the application for a user. For example, a user can selectively reduce a large number of items displayed in a folder/menu structure, of which the user may only frequently use a small number of these items, so as to optimise a folder/menu structure to their personal preferences. This can also allow for easy restoration or access to the hidden items in the future.

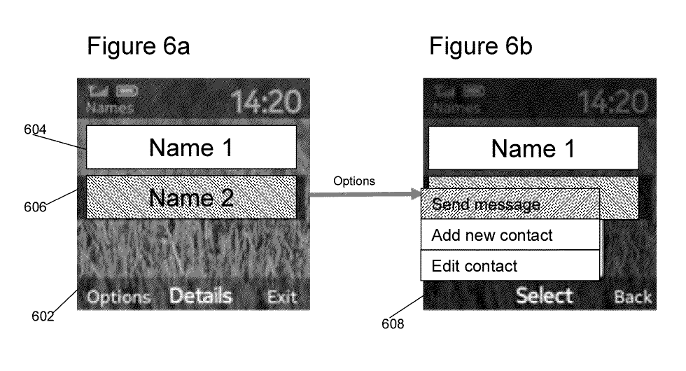

FIGS. 6a and 6b illustrate user interfaces 602, 608 according to an embodiment of the present disclosure.

FIG. 6a illustrates a user interface 602 that is displayed after a user has selected a “contacts” selectable item in a higher level of a menu structure. The user interface 602 includes the names 604, 606 of two people in the user's contact list. Displaying only the user's names represents a simplification of a full (with no hidden items) display. That is, the contacts information has been simplified by hiding all information apart from the contact's name.

FIG. 6b illustrates a user interface 608 that is displayed when a user selects “options” for one of the contacts that is highlighted in FIG. 6a. In the user interface 608 of FIG. 6b, a subset of only three menu items is displayed on the graphical user interface 608. That is, all other options menus have been hidden.

According to some embodiments of the present disclosure, a user can select one or more selectable items to be hidden from a subsequently displayed user interface one by one. Such examples are discussed above. Alternatively, a user can select one or more preset selectable items that are to be hidden. The preset selectable items may be associated with a “menu style” or “profile”, for example. Such “menu styles” can provide a convenient way for a user to utilise popular user interfaces and/or tailor a display with one or relatively section operations. In some examples, the “menu styles” can be personalised.

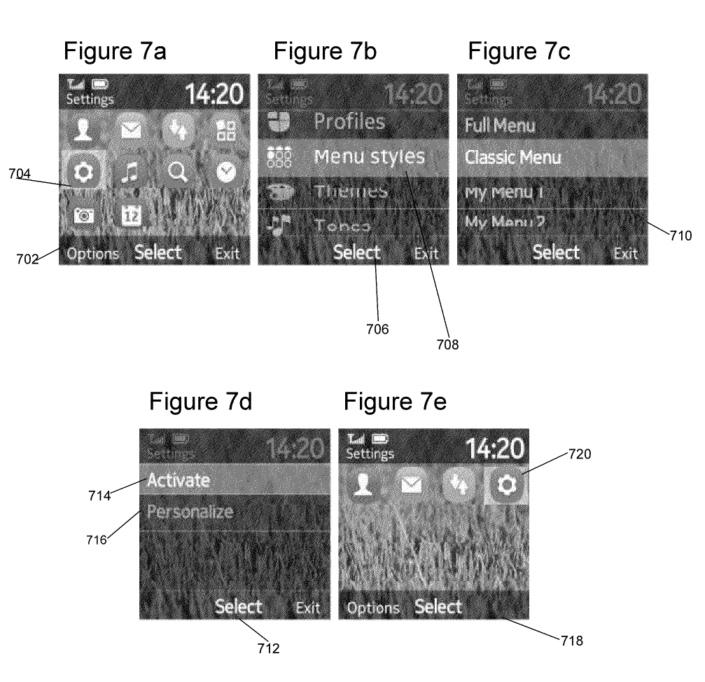

FIGS. 7a to 7e illustrate user interfaces according to an embodiment of the present disclosure that can be used to activate a preset menu style.

The user interface 702 of FIG. 7a shows a user interface 702 that is displaying ten menu icons. One of the menu icons is a settings icon 704. If the user selects the settings icon 704, then the user interface 706 of FIG. 7b is displayed.

The user interface 706 of FIG. 7b includes a “menu styles” 708 option. As will be appreciated from the discussion that follows, the “menu styles” functionality can provide the user with a convenient way of implementing a preselected number of settings. In this example the “menu styles” functionality provides a preselected indication of which selectable items are to be hidden.

When the user selects the “menu styles” option of FIG. 7b, the user interface 710 of FIG. 7c is displayed to provide a number of “menu styles” options to a user. These options include: a “full menu” option, in which case none of the selectable items are hidden; and three specific menu styles. The specific menu styles of this example are “Classic Menu”, “My Menu 1”, and “My Menu 2”. Each of these menus has a predefined list of selectable items that will be hidden when the associated menu style is selected.

When a user selects one of the menu styles shown in FIG. 7c, the user interface 712 of FIG. 7d is displayed. The user is then presented with the option of activating the selected menu by pressing the “activate” button 714 or customising the menu by selecting the “personalise” button 716.

If the user selects the “activate” button 714 then the user interface 718 of FIG. 7e is displayed. In this example, the selected menu style includes four selectable icons.

In this embodiment, the settings icon 720 is always displayed to a user to provide the user with functionality for subsequently changing the menu style. That is, the settings icon 720 cannot be hidden as it would take away the functionality for the user to reconfigure which items are hidden in this example. In other examples, the user could also access the configuration via alternative or additional ways than through a settings icon/application. For example, by performing a gesture on a touch screen/hovering interface that would display the configuration interface. In such an embodiment the settings icon 720 could be hidden or be visible.

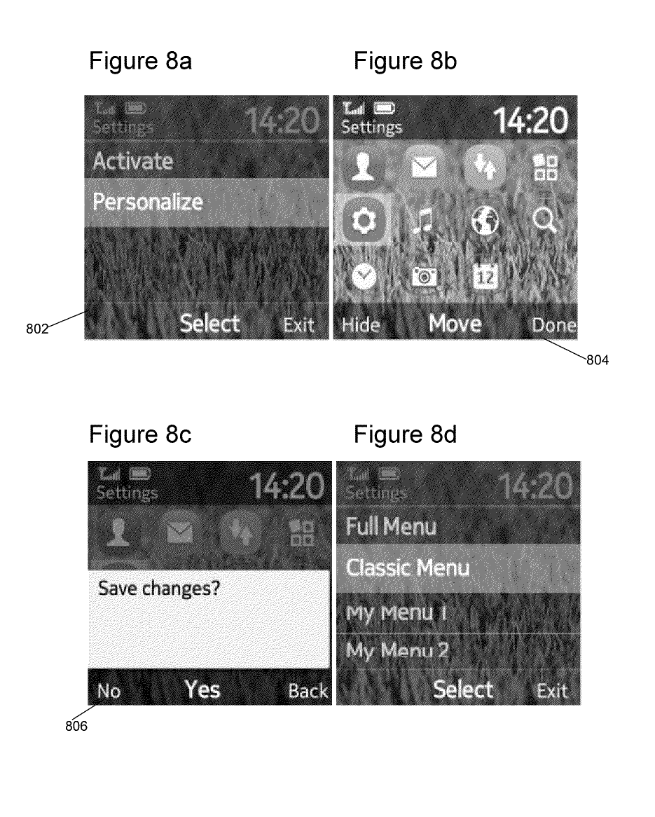

FIGS. 8a to 8d illustrate the functionality of an embodiment of the present disclosure when a user decides to personalise a predefined menu style, thereby modifying which items are to be hidden. The user interface 802 of FIG. 8a is similar to that of FIG. 7d. The following discussion of FIGS. 8b to 8d represents user interfaces that are displayed when the user selects the personalise option, as opposed to the user interface that is displayed when a user activates a menu style as shown in FIG. 7e.

FIG. 8b illustrates a user interface 804 that can be used to hide icons on the user interface, or cancel the hiding icons that are preselected to be hidden. The functionality illustrated by FIG. 8b is described above with reference to FIGS. 3 and 4, and therefore does not require further explanation here. Initially, the status of the icons that are displayed (that is, hidden or not hidden) corresponds with the preset menu style.

Once the user has made their selections using user interface 804 of FIG. 8b, they can confirm the changes using the user interface 806 of FIG. 8c. The user interface then returns to the settings display described above with reference to FIG. 7c, and illustrated here in FIG. 8d, such that the user can activate the menu style if desired.

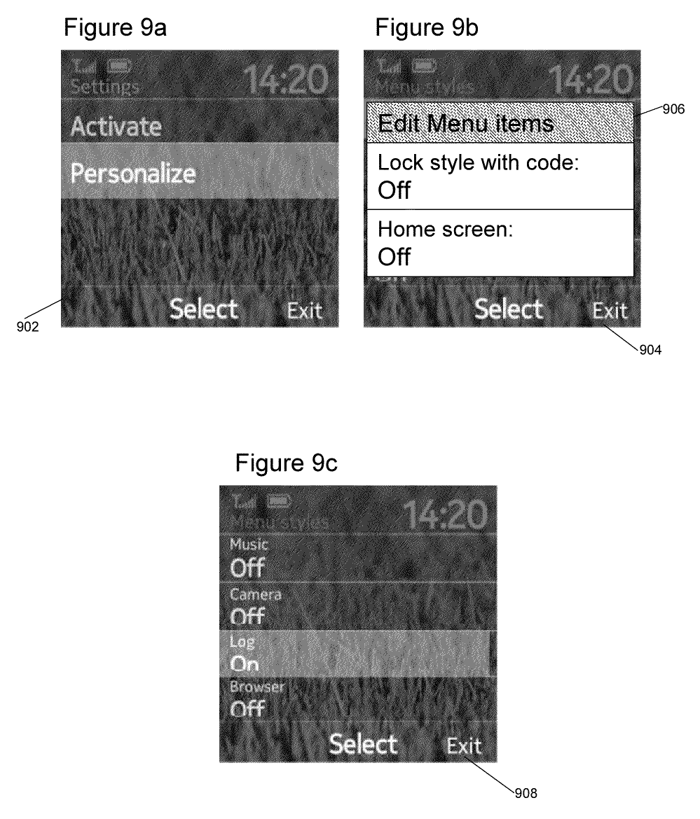

FIGS. 9a to 9c illustrate a further embodiment of personalising a preset menu style according to an embodiment of the present disclosure. Using the user interface 902 of FIG. 9a, a user indicates a desire to personalise a menu style. This causes the user interface 904 of FIG. 9b to be displayed.

The personalise options shown in FIG. 9b include a “lock style with code” option, which can be set as on or off, such that a selected menu style can be changed, or the configuration interface or options accessed, upon successfully entering a code or password.

The user may enable or disable a home screen using the corresponding personalise option shown in user interface 904 of FIG. 9b. When the home screen is disabled, the top level menu is visible as a main display. Therefore, an “exit” soft key may not be necessary when viewing the home screen. The “exit” functionality can be hidden.

The user can select a personalise option 906 to edit the menu items. If the user selects this option, then the user interface 908 of FIG. 9c is displayed. As shown in FIG. 9c, each of the selectable items is shown as a line of text. Each of the items may be selected as on or off to represent whether or not the corresponding icon will be displayed on the user interface.

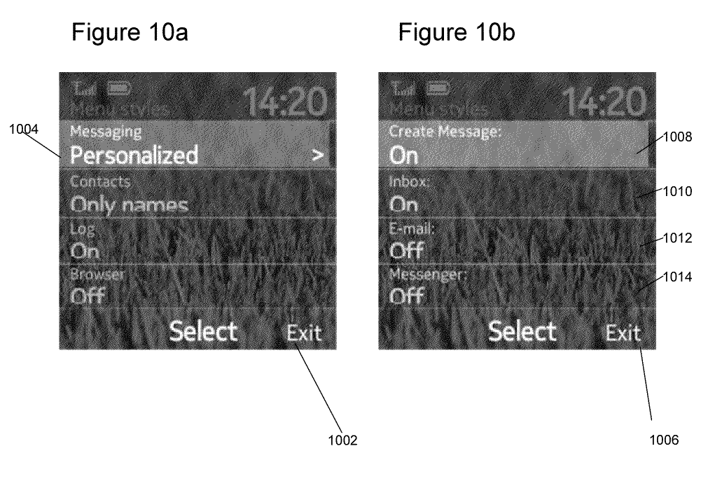

FIGS. 10a and 10b illustrate alternative functionality that can be provided when a user selects the edit menu items option 906 of FIG. 9b.

FIG. 10a illustrates a user interface 1002 that illustrates an alternative way of hiding selectable items that is more sophisticated than simply enabling an item to be switched on or off. The first such example in FIG. 10a is the “messaging” button 1004, the selection of which causes the user interface 1006 of FIG. 10b to be displayed. The user interface 1006 of FIG. 10b enables selectable items below the messaging application level to be hidden too. For example, four selectable items 1008, 1010, 1012, 1014 that are only displayed to a user after selection of a higher level (in a hierarchical structure) messaging item are shown. The selectable items 1008, 1010, 1012, 1014 may be referred to as sub-selectable items. Each of these sub-selectable items 1008, 1010, 1012, 1014 can be set as on or off in order to hide the corresponding selectable item from the user interface.

For the example of FIG. 10b, only the “create message” 1008 and inbox “inbox” 1010 selectable items have not been selected for hiding. This would result in display of the user interface 110 of FIG. 1b if a user subsequently selects a messaging icon.

It will be appreciated that the embodiments disclosed herein are non-limiting. For example, it is not essential to use an interface that involves soft keys and directional buttons. Indeed, a different mechanism can be use to unhide items than is used to hide items. In some embodiments no keystrokes on a keypad may be required at all, for example a purely or partly touch screen interface could be used. In some examples, drag and drop functionality can be used to hide or unhide items. In one implementation, a user could drag and drop items into a “hide bin” to hide items.

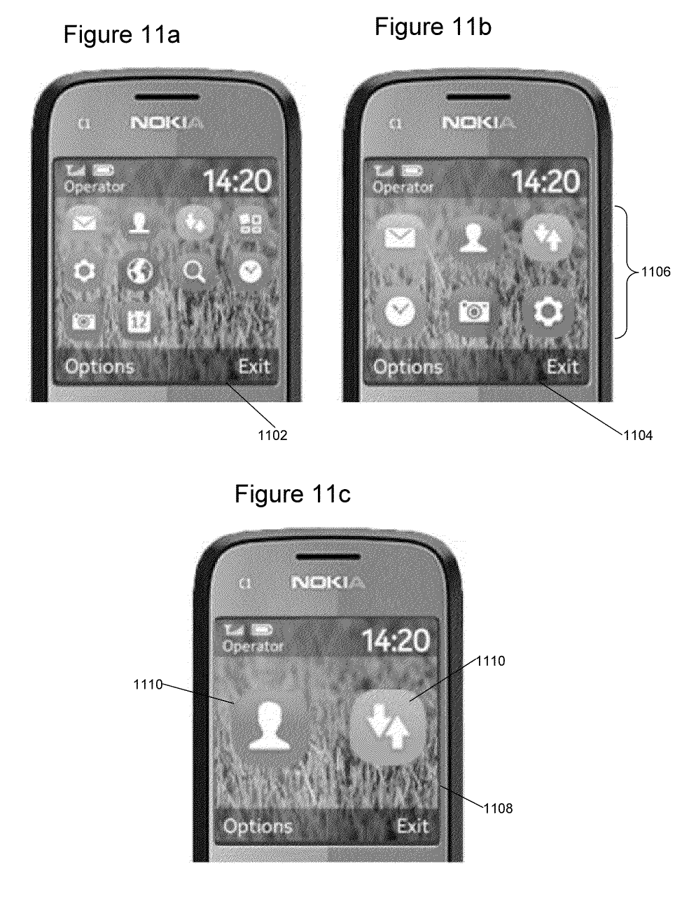

FIGS. 11a to 11c illustrate user interfaces according to another embodiment of the present disclosure.

FIG. 11a illustrates a user interface 1102 where few selectable items have been hidden such that eleven selectable items/icons are displayed to a user. Each of the selectable items is visible on the display at the same time.

FIG. 11b illustrates a user interface 1104 whereby only six selectable items/icons are displayed to a user because the remaining items/icons have been hidden. The six remaining items/icons 1106 are automatically resized such that they occupy substantially all of the user interface display, or any other predefined region or proportion of the display. The degree to which the selectable items/icons 1106 are resized is based at least in part on the number of remaining icons (six in the example of FIG. 11b). The amount of resizing may take into account characteristics of the display, such as the width, height, resolution of the display, or any other characteristics that can affect how many, and what size, items can be displayed.

FIG. 11c shows a user interface 1108 in which only two icons 1110 are displayed. In accordance with the functionality described above in relation to FIG. 11b, the two icons 1110 of FIG. 11c are further increased in size in order to, between them, occupy a large proportion of the display screen.

The size of an icon/representation may be automatically set in accordance with the number of icons/representations that are to be hidden and/or the number of icons/representations that are to be displayed.

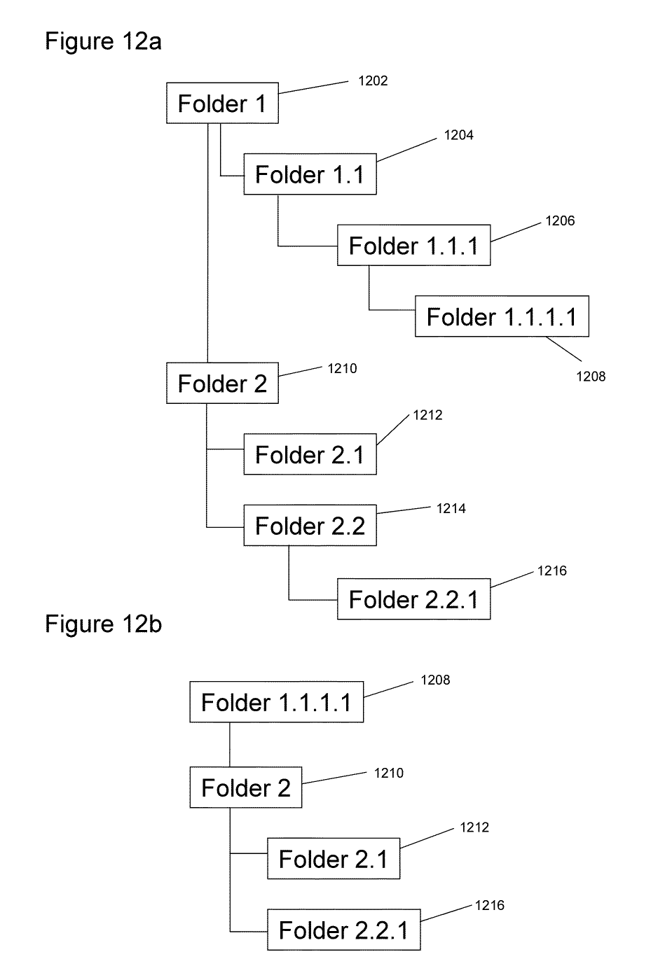

FIG. 12a illustrates an example hierarchical structure that can be displayed to a user as part of a user interface. FIG. 12b illustrates a user interface according to an embodiment of the present disclosure for displaying the hierarchical structure of FIG. 12a.

In this example the hierarchical structure is shown as a folder structure, wherein the folders and sub-folders are examples of selectable items. It will be appreciated that a user may have to select any folder in order to view its sub-folders. That is, all of the sub-folders may not necessarily be displayed at the same time.

It will also be appreciated that one or more of the folders or sub-folders, especially the folders at the end of a branch in the structure may be applications or documents or any other file type.

The folder structure of FIG. 12a has two top level folders: folder 1 1202 and folder 2 1210. Folder 1 1202 has one sub-folder 1204, which also has one sub-folder 1206, which also has one sub-folder 1208. Folder 2 has two sub-folders 1212, 1214. The second sub-folder 1214 has one sub-folder 1216.

A hierarchical structure can have branches, with selectable items at different layers/levels in the branch. As an example for FIG. 12a, a first branch consists of folders: folder 1 1202, folder 1.1 1204, folder 1.1.1 1206 and folder 1.1.1.1 1208. Each of these folders is at a different layer in the hierarchical structure.

In order for a user to navigate to a lower level folder, they may have to individually select each of the higher level folders. In some examples, selecting each of the higher level folders may cause a separate user interface to be displayed.

FIG. 12b shows a hierarchical structure according to an embodiment of the present disclosure. The hierarchical structure may be displayed as it is shown in FIG. 12b, or may be used to generate user interfaces for displaying as the user navigates through the hierarchical structure.

As shown in FIG. 12b, any sub-folder that is the only item at that level in a branch of the structure of FIG. 12a has been elevated to the next level in the branch. For example, folder 2.2.1 1216 is the only sub-folder from folder 2.2 1214 in FIG. 21a, and therefore, folder 2.2.1 1216 has replaced folder 2.2 in FIG. 12b. This can enable the user to more quickly and conveniently access folder 2.2.1 1216.

This elevation of sub-folders can be cascade, as shown in FIG. 12b for folder 1.1.1.1 1208. As folder 1.1.1.1 1208 is the only item at the fourth level in the first branch of the hierarchical structure of FIG. 12a, it is elevated to the third level. In turn, the elevated folder 1.1.1.1 would now be the only item at the third level of the first branch and therefore it is elevated again. As will be appreciated from FIG. 12a, this cascaded elevation continues until folder 1.1.1.1 1208 is at the first level of the first branch, such that folder 1.1.1.1 1208 replaces folder 1 1202 in FIG. 12b.

In this example, a selectable item that is determined as being the only item at a specific level in a branch is used to replace the item at the highest level of that branch in the hierarchical structure for which there is only one selectable item in each level of the branch. In this way, any intermediate levels in the hierarchical structure (such as intermediate folders) can be automatically hidden.

In some examples, the number of items in a layer of the hierarchical structure can be compared with a threshold number to determine whether or not the item should be elevated to a higher level in the structure. In the example of FIG. 12b, the threshold is set as one, but other threshold values could also be used.

In some embodiments, the threshold number may be automatically set based at least in part on the number of selectable items in the higher level of that branch. For example, the number of free spaces for displaying additional selectable items in the higher level. For the embodiment of FIG. 12, if the highest level can display three selectable items simultaneously then the threshold is set as three. When this threshold is applied to the structure of FIG. 12a, each of the three folders: folder 1.1.1.1 1208, folder 2.1 1212, and folder 2.2.1 1216 can be applied at the highest level of the structure.

It will be appreciated that the functionality that is described above with reference to FIGS. 12a and 12b can also be used for other hierarchical structures, including hierarchical menu structures whereby only one level in the menu structure may be displayed at any one time.

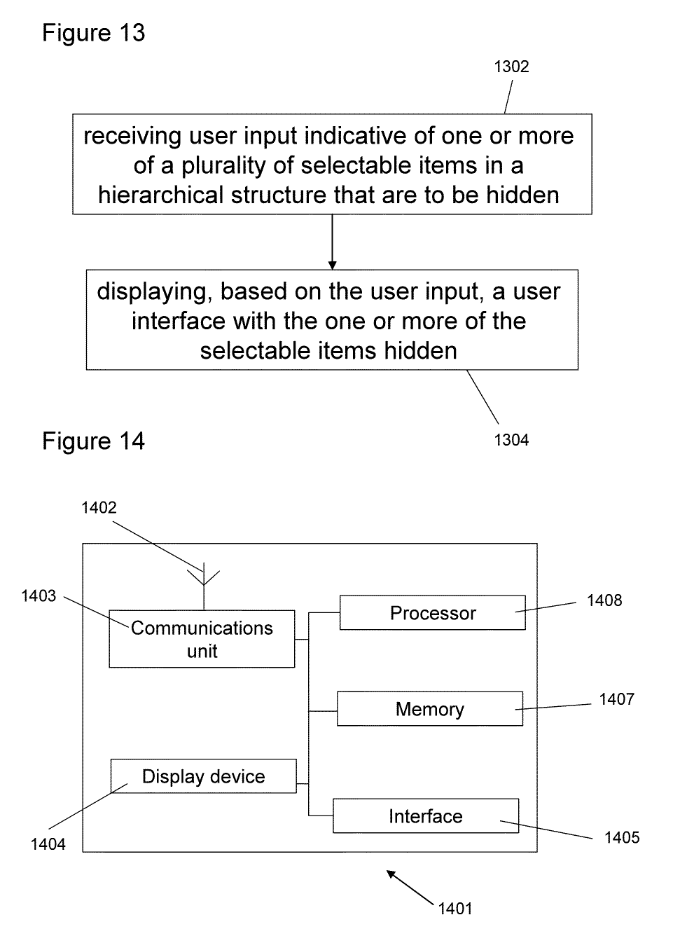

FIG. 13 illustrates the process flow according to an embodiment of the present disclosure.

The process begins at step 1302 by receiving user input indicative of one or more of a plurality of selectable items in a hierarchical structure that are to be hidden. As will be appreciated from the above description, there are a number of different ways in which a user can provide this input, including providing a selection of items one by one or selecting a preset list of selectable items (such as through use of “menu styles”). The user may indicate which items are to be hidden or which items are to maintained on the display.

At step 1304, the method process continues by displaying, based at least in part on the user input, a user interface with the one or more of the selectable items hidden. In this way, a customized user interface can be provided to the user in order to improve the usability of a device or apparatus associated with the process.

In any of the examples disclosed herein, feedback could be provided to a user during normal operation when a user is viewing a user interface that has hidden items. The feedback could be haptic, audio or visual. This can be helpful to the user if he or she does not remember what icons/items have been hidden. The feedback could indicate that there are hidden icons/items in the structure that is being navigated. This can help the user to quickly get the information that some items in this level have been hidden and avoid the user having to go through the menus to check if options/icons have been hidden. This feedback mode could be activated in accordance with user selection of an associated option.

FIG. 14 illustrates an apparatus 1401 according to an embodiment of the present disclosure, and can be considered as a development of the apparatus described above with reference to FIG. 15. The apparatus 1401 may be considered as just the processor 1408 and memory 1407 shown in FIG. 14. Alternatively, the apparatus may be considered as a device 1401 or module that includes the processor 1408 and memory 1407, and optionally one or more of the other components that are shown in FIG. 14. The device 1401 may be a mobile telephone, a smartphone or any other portable or non-portable electronic device.

The example embodiment of FIG. 14 in this case, comprises a display device 1404 such as, for example, a Liquid Crystal Display (LCD) or touch-screen user interface, or hovering user interface. The apparatus 1401 of FIG. 14 is configured such that it may receive, include, and/or otherwise access data. For example, this example embodiment 1401 comprises a communications unit 1403, such as a receiver, transmitter, and/or transceiver, in communication with an antenna 1402 for connecting to a wireless network and/or a port (not shown) for accepting a physical connection to a network, such that data may be received via one or more types of networks. This example embodiment comprises a memory 1407 that stores data, possibly after being received via antenna 1402 or port or after being generated at the user interface 1405. The processor 1408 may receive data from the user interface 1405, from the memory 1407, or from the communication unit 1403. It will be appreciated that, in certain example embodiments, the display device 1404 may incorporate the user interface 1405. Regardless of the origin of the data, these data may be outputted to a user of apparatus 1401 via the display device 1404, and/or any other output devices provided with apparatus. The processor 1408 may also store the data for later user in the memory 1407. The memory 1407 may store computer program code and/or applications which may be used to instruct/enable the processor 1408 to perform functions (for example, read, write, delete, edit or process data).

It will be appreciated that any data exchange between the processor 1408 and the memory 1407 can be considered as an active coupling between these components to allow the processor 1407 to access computer program code stored in memory 1408.

FIG. 16 illustrates schematically a computer/processor readable media 1600 providing a program according to an embodiment of the present disclosure. In this example, the computer/processor readable media is a disc such as a digital versatile disc (DVD) or a compact disc (CD). In other embodiments, the computer readable media may be any media that has been programmed in such a way as to carry out an inventive function.

It will be appreciated that any discussion of a specific means for a user to provide input described herein is non-limiting. Any input means or selection mechanism can be used, such as touch sensors, sensors that detect an input device (which may be a finger or a pointer or anything else) hovering over a selectable icon, sensors that detect double tapping on a selectable icon, drag and drop functionality, and the like.

It will be appreciated to the skilled reader that any mentioned apparatus/device/server and/or other features of particular mentioned apparatus/device/server may be provided by apparatus arranged such that they become configured to carry out the desired operations when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out various example embodiments, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
receive user input indicative of one or more of a plurality of selectable items in a hierarchical structure that are to be hidden; and
display, based at least in part on the user input, a user interface with the one or more of the selectable items hidden.

2. The apparatus of claim 1, configured to display, based at least in part on the user input, a user interface that includes those selectable items that are not the one or more selectable items that are to be hidden.

3. The apparatus of claim 1, wherein the user input represents one or more of the plurality of selectable items that are to be hidden.

4. The apparatus of claim 1, wherein the user input represents one or more of the plurality of selectable items that are to be displayed.

5. The apparatus of claim 1, wherein the hierarchical structure is a menu structure, and the user input is indicative of a plurality of the selectable items at different levels in the menu structure.

6. The apparatus of claim 1, wherein the hierarchical structure is a folder structure, and the user input is indicative of a plurality of the selectable items in folders and sub-folders in the folder structure.

7. The apparatus of claim 1, wherein the user input is indicative of one or more preset selectable items in a hierarchical structure that are to be hidden.

8. The apparatus of claim 7, wherein the one or more preset selectable items are associated with a user selectable “menu style”.

9. The apparatus of claim 8, wherein the one or more preset selectable items are modifiable by a user.

10. The apparatus of claim 1, wherein the apparatus is further configured to:
receive user input indicative of a desire to select which of the plurality of selectable items are to be hidden; and
display a user interface with all of the plurality of selectable items, including the selectable items that have been identified as hidden.

11. The apparatus of claim 10, further configured to receive user input indicative of one or more of a plurality of selectable items in a hierarchical structure that are to be hidden or un-hidden.

12. The apparatus of claim 1, further configured to display, as a home screen, the user interface for the top level in the hierarchical structure with the one or more of the selectable items hidden.

13. The apparatus of claim 1, wherein one or more of the selectable items are configured to be prevented from being hidden.

14. The apparatus of claim 1, further configured to determine if the number of selectable items in a level of a branch of the hierarchical structure is less than or equal to a threshold number, and if it is, display the selectable item/s at a higher level of that branch in the hierarchical structure.

15. The apparatus of claim 14, wherein the threshold number is automatically set based at least in part on the number of free spaces for displaying additional selectable items in the higher level.

16. The apparatus of claim 1, further configured to set the size of a representation for each of the selectable items to be displayed in accordance with the number of selectable items that are to be hidden from the user interface.

17. The apparatus of claim 16, further configured to set the size of the representations such that all of the displayed representations occupy a predefined region of the user interface.

18. The apparatus according to claim 1, wherein the apparatus is at least one of a portable electronic device, circuitry for a portable electronic device, a pocket computer, a laptop computer, a desktop computer, a tablet computer, a mobile phone, a Smartphone, a monitor, a display, a personal digital assistant or a digital camera or a module for the same.

19. A method comprising:
receiving user input indicative of one or more of a plurality of selectable items in a hierarchical structure that are to be hidden; and
displaying, based at least in part on the user input, a user interface with the one or more of the selectable items hidden.

20. A computer program comprising computer program code configured to, when run on at least one processor, perform at least the following:
receive user input indicative of one or more of a plurality of selectable items in a hierarchical structure that are to be hidden; and
display, based at least in part on the user input, a user interface with the one or more of the selectable items hidden.
